(19) United States
(12) Patent Application Publication
(10) Pub. No.: US 2012/0110945 A1
(43) Pub. Date: May 10, 2012

(54) Composites and Methods of Formation Thereof

(76) Inventors: Henry Hoang, Arlington, TX (US); Trung Nam Dang, Ho Chi Minh City (VN)

(21) Appl. No.: 12/943,543

(22) Filed: Nov. 10, 2010

(51) Int. Cl. E04B 2/02; E04C 2/04; B28B 1/00; B28B 1/14; B28B 1/24; B32B 13/02; E04C 3/20

(52) U.S. Cl. 52/596; 428/323; 428/325; 428/331; 52/831; 264/299; 264/328.6; 264/330; 264/39

(57) ABSTRACT

In one embodiment, a method of forming a composite material includes drying organic raw material to remove moisture to less than about 18%. The organic raw material is milled to form organic fiber particles having a size less than about 10 mm. A glue is formed by adding magnesium oxide, magnesium chloride, and water. The glue is mixed with the organic fiber particles to form a slurry. A mold cavity of a mold is filled with the slurry. A pattern is formed by allowing the slurry to set within the mold cavity.

### TECHNICAL FIELD

The present invention relates generally to composites, and more particularly to composites and methods of formation thereof.

### BACKGROUND

With increased threat of global warming and other environmental threats, there has been a growing concern towards sustainable production methods and biodegradable products. Although much effort has been focused towards developing bio-degradable materials, most of such materials are not suitable for high strength and high temperature applications. Alternatively, bio-composite materials with good physical and mechanical properties include materials that are non-biodegradable, require toxic chemicals during fabrication, or large amounts of energy in their production, and typically a combination of all of these. For example, many bio-composite materials include resins made from volatile organic compounds such as formaldehyde, which may increase their toxicity to the environment, both during and post production, while requiring high temperatures (energy) for the baking processes.

Hence, what is required are composite materials that have the good physical, mechanical, chemical, and electrical properties while being formed using a sustainable production process.

### SUMMARY OF THE INVENTION

These and other problems are generally solved or circumvented, and technical advantages are generally achieved, by illustrative embodiments of the present invention.

In one embodiment, a composite material comprises a magnesium cement matrix comprising magnesium oxide and magnesium chloride. Organic fiber particles are disposed in the magnesium cement matrix. The organic fiber particles have less than 15% moisture and are less than 10 mm in size. The magnesium cement matrix and the organic fiber particles form the composite material.

In an alternative embodiment, a building comprises a wall. The wall comprises composite material bricks, which comprises a magnesium cement matrix comprising a magnesium oxide and magnesium chloride. Organic fiber particles are disposed in the magnesium cement matrix. The organic fiber particles have less than 15% moisture and are less than 10 mm in size. The magnesium cement matrix and the organic fiber particles form a composite material.

In yet another embodiment, a method of forming a composite material comprises drying organic raw material to remove moisture to less than about 18%. The method further comprises milling organic raw material to form organic fiber particles having a size less than about 10 mm. A pre-glue mixture is formed by adding magnesium oxide, magnesium chloride, and water. A catalyst is added to the pre-glue mixture to form a glue. The glue is mixed with the organic fiber particles to form a slurry. The mold cavity of a mold is filled with the slurry. A pattern is formed by allowing the slurry to set within the mold cavity.

In an alternative embodiment, a method of forming a composite material comprises milling the inorganic crystalline material to form pellets having a size less than about 1 mm. A glue is formed by adding magnesium oxide, magnesium chloride, and water. The glue is mixed with the pellets to form a slurry. A mold cavity of a mold is filled with the slurry. A pattern is formed by allowing the slurry to set within the mold cavity.

In an alternative embodiment, a production process for making a composite material comprises drying organic raw material to remove moisture to less than about 18%. The organic raw material is milled to form organic fiber particles having a size less than about 10 mm. Ground solid waste is incorporated with the organic fiber particles. A pre-glue mixture is formed by adding magnesium oxide, magnesium chloride, and water. A catalyst is added to the pre-glue mixture to form a glue. The catalyst is selected from the group consisting of K₂SO₄, ZnSO₄, CuSO₄, and K₃(Fe(CN)₆). The glue is mixed with the organic fiber particles to form a slurry. A mold cavity of a mold is filled with the slurry. A pattern is formed by allowing the slurry to set within the mold cavity. The ground solid waste is obtained from cleaning components used in the forming the composite material.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a structure of a composite material in accordance with embodiments of the invention;

FIG. 2 illustrates the major process steps of a production process used in the forming of the composite material in accordance with embodiments of the invention;

FIG. 3 illustrates the materials preparation steps in accordance with embodiments of the invention;

FIG. 4 illustrates the operations in the formation of the glue in accordance with embodiments of the invention;

FIG. 5 illustrates molding process operations in accordance with embodiments of the invention;

FIGS. 6a and 6b describe waste treatment operations in accordance with embodiments of the invention, wherein FIG. 6a describes liquid waste water operations, and wherein FIG. 6b describes solid waste operations;

FIG. 7, which includes FIGS. 7a-7c, illustrates a structure of a composite material in accordance with embodiments of the invention;

FIG. 8, which includes FIGS. 8a-8c, illustrates a structural composite in accordance with an embodiment of the invention, wherein FIG. 8a illustrates a cross sectional view and FIGS. 8b and 8c illustrate alternative embodiments of 1-D concentration profiles;

FIG. 9, which includes FIGS. 9a-9c, illustrates a structural composite in accordance with an alternative embodiment of the invention;

FIG. 10 illustrates process operations in forming a reinforced composite in accordance with embodiments of the invention;

FIG. 11 illustrates process operations in forming marble composites in accordance with an embodiment of the invention; and

FIG. 12 illustrates alternative waste treatment operations in accordance with embodiments of the invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of various embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments of the invention describe a bio-composite material formed from organic materials using a sustainable production processes. In various embodiments, the bio-composite materials are agricultural by-products which require minimal energy for production (minimal carbon footprint). Further, the production process is green and eco-friendly in that liquid and solids wastes are almost completely recycled.

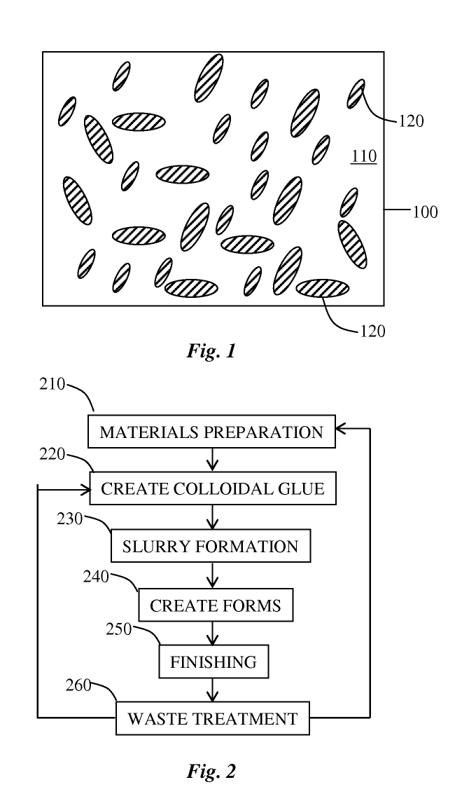

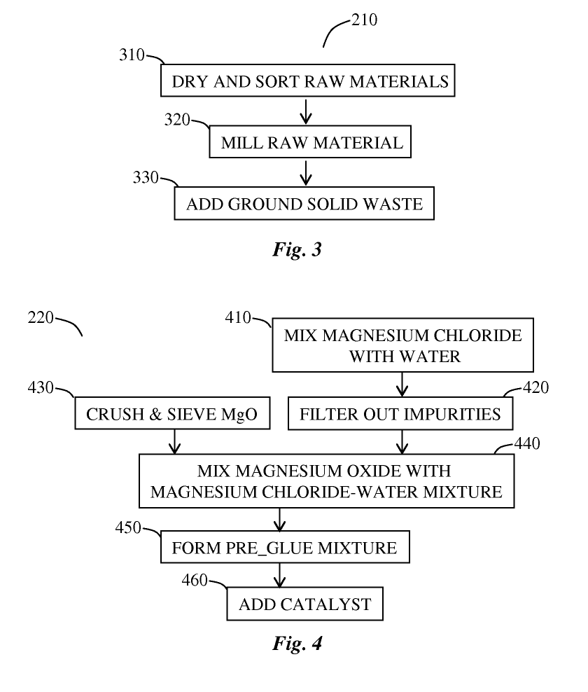

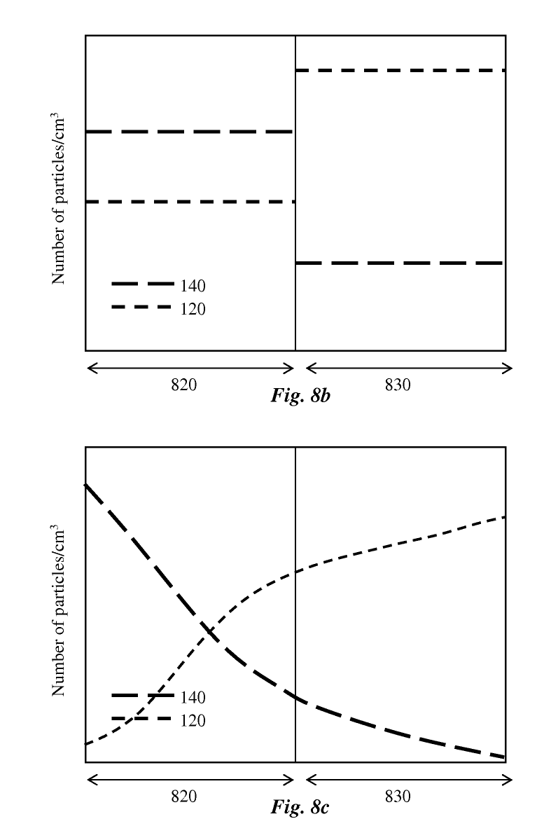

A structural embodiment will be described using FIG. 1. Further structural embodiments will be described using FIGS. 7-9. Embodiments of a method of forming a composite material will be described using FIGS. 2-6, and FIGS. 10-12.

FIG. 1 illustrates a structure of a composite material in accordance with embodiments of the invention.

Referring to FIG. 1, the composite material 100 comprises organic fiber particles 120 disposed in a magnesium cement matrix 110. In various embodiments, the organic fiber particles 120 have less than 18% moisture and less than about 15% moisture in one embodiment. In various embodiments, the organic fiber particles 120 are less than 10 mm, and about 1 mm to about 5 mm in dimension in one embodiment.

In various embodiments, the organic fiber particles 120 comprise grass, straw, husks such as rice, wheat, and/or corn husks. In some embodiments, the organic fiber particles 120 may also comprise bagasse, which is the sugar cane fiber left after juice extraction, beans/peas (the main component), bamboo, corn cobs, and any other plant by product from agriculture. In various embodiments, the actual percentage of raw materials used such as straw, rice husk, bagasse, etc. may also depend on the location of the manufacturing facility. In general, materials with a high degree of water absorption such as straw, bagasse may be combined with 30-50% of materials with low degree of water absorption such as rice husks, bamboo powder etc. This percentage will make the mixing process easier. When using more materials with high degree of water absorption, water may be added to soften the mixture, making the manufacturing process easy.

The magnesium cement matrix 110 comprises a magnesium oxide and magnesium chloride cement in various embodiments. In one embodiment, the magnesium cement matrix 110 comprises [(m(MgO))nMg²⁺(2n-x)Cl⁻]^{x+}xCl⁻. In this formula, the ratio of magnesium oxide (MgO) and magnesium chloride (MgCl₂) in the magnesium cement matrix 110 is given by the ratio of m and n. In one or more embodiment, the ratio of m to n is about 3:1.2. In one embodiment, m is about 3, and n is about 0.95. The ratio (m/n) determines the hardness of the composite material 100. For example, for increasing the hardness, the concentration of magnesium oxide relative to magnesium chloride is decreased. Alternatively, for increasing the toughness (or decreasing hardness), the relative concentration of magnesium oxide is increased. In various embodiments, the magnesium cement matrix 110 in the composite material 100 is less than about 20% by volume.

The composite material 100 has excellent mechanical properties. In various embodiments, the bending endurance of the composite material is at least 14 MPa. Similarly, the impact endurance of the composite material is at least 2 Kg/m². The breakage endurance is at least 40 N/mm. Despite the excellent endurance, the material has good strength to weight ratio having a density of about 0.9 to about 1.0 gm/cc. The composite material 100 is not hygroscopic and non-porous with a volumetric expansion after water immersion less than about 0.55%. The impermeability towards moisture also helps to protect underlying layers from environmental corrosion.

The composite material 100 has very good thermal properties and is resistant to heat up to 1200° C. to about 1300° C. with a melting point which is much higher (typically greater than 1500° C.). The composite material 100 has a burning point of at least 800° C. The burning point is measured by the oxidation resistance when being exposed to a flame torch for 120 minutes. Similarly, the coefficient of expansion of the composite material 100 is less than and equal to about 5×10⁻⁶ m/m K.

In various embodiments, the composite material 100 may be shaped to any needed form. In one or more embodiments, the composite material 100 may be formed as bricks, which may then be used in the construction of structures such as buildings, walls, infrastructure such as roads, bridges, etc. The composite material 100 may be a prefabricated slab in some embodiments and may be manufactured off-site.

In alternate embodiments, the composite material 100 may be used as a substitute for wood, e.g., in load bearing poles for building houses, electric poles, shingles (for roofing), doors, windows, furniture as well as big lumbar for buildings and structures including lumbar used in their construction such as scaffolding structures.

In alternate embodiments, the composite material 100 may be used as a substitute for marble and/or other tile products used for finishing floors and other surfaces. In further embodiments, the composite material 100 may be used in roofing, for example, as shingles because of the small thermal conductivity and excellent resistance to moisture.

Advantageously, the composite material 100 does not comprise any plastics and is therefore eco-friendly with no biodegradation issues unlike plastics.

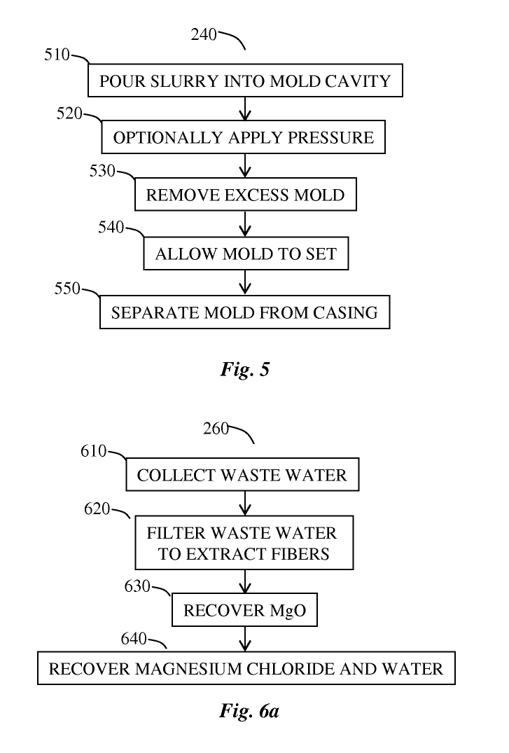

FIGS. 2-6 illustrate a production process used in the forming of the composite material in accordance with embodiments of the invention, wherein FIG. 2 illustrates the major process steps while FIGS. 3-6 illustrate unit processes used in fabricating the composite material.

Referring first to FIG. 2, the production process starts with materials preparation (step 210). FIG. 3 illustrates the materials preparation steps in accordance with embodiments of the invention. As further described in FIG. 3, the material preparation 210 involves cleaning and drying raw materials (step 310). The raw materials comprise organic materials in one embodiment. In various embodiments, the organic raw materials are by products from agriculture. In one or more embodiments, organic raw materials comprise grass, straw, husks such as rice, wheat, corn husks, bagasse, which is the sugar cane fiber left after juice extraction, beans/peas (the main component), various kinds of bamboo, corn cobs. However, in various embodiments, besides organic materials, the raw materials may also comprise metal and/or glass particles.

In various embodiments, the organic fiber particles different class of organic raw materials may be used. As one example, organic materials having different water absorption coefficients may be mixed. In various embodiments, the a first type of organic material having a high water absorption may be mixed with a second type of organic material having a low water absorption in ratio of about 1:1.2 to about 0.8:1. Examples of the first type of organic material include rice husks, bamboo whereas examples of the second type of organic material include straw, bagasse etc. Using a higher percentage of the first type of organic material allows for higher degree of compression of the subsequent composite. In contrast, a higher percentage of the second type of organic material enables formation of smooth finished surfaces and easier to blend and mold. Further, additional water must be added if a higher percentage of the second type of organic material is used and requires longer mold setting times.

In various embodiments, the drying operation may be performed by exposing the raw materials to direct sun. In an alternate embodiment, the raw materials are heated between about 40° C. to about 90° C. in a furnace. Rotten material, if any, is removed either before and/or after the drying process. Further, the raw materials may be sorted into different sized bins for improving the efficient of the subsequent milling process.

The dried and sorted organic materials are next milled and cut into particles or fibers to form organic fiber particles. The organic fiber particles have a size less than about 10 mm, and in one case from about 1 to about 5 mm in size (step 320). The organic fiber particles may be mixed with recycled sold waste, which will be described further below. Advantageously, this recycling enables to minimize wastage without increasing the cost of production.

In various embodiments, if other raw materials are used, they are also dried, sorted and milled. For example, inorganic particles such as fiberglass may be added in some embodiments. In one or more embodiments, similarly, metal particles may be added.

In one or more embodiments each type of raw materials is prepared separately (dried, sorted, and in some embodied milled separately). For example, rice husks may be dried, sorted, milled in a facility separate from the preparation of grass and hay. By processing different raw materials separately, better process control can be achieved. For example, removing waste (such as rotten) products may be easier when processed separately. Advantageously, this allows to select the relative ratio of these raw materials in the final composite material thereby tailoring the properties of the product. After the drying, the moisture content within the raw materials is less than 20%, and about 13% to about 18% in one embodiment.

As next illustrated in FIG. 2, a glue is next formed (step 220). Steps 210 and 220 of FIG. 2 can be performed in parallel in different physical locations in various embodiments.

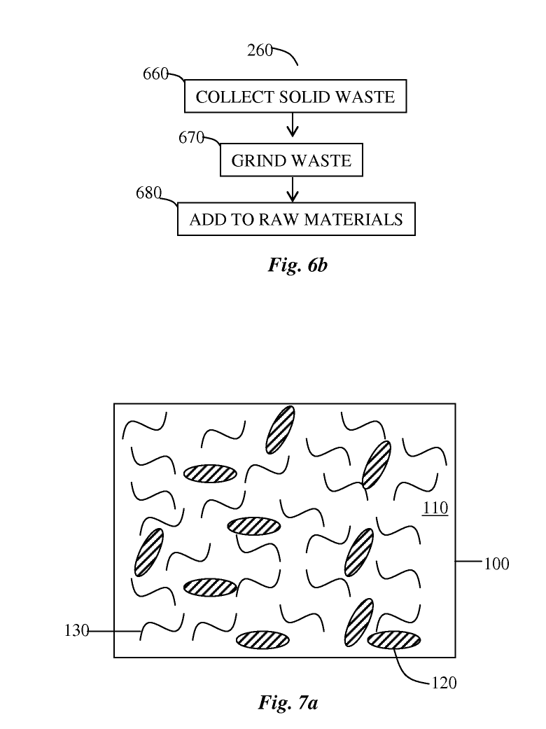

The formation of the glue is next described using FIG. 4 in accordance with embodiments of the invention. A pre-glue mixture is first formed by adding magnesium oxide, magnesium chloride, and water. As illustrated in FIG. 4, step 410, magnesium chloride is mixed with water. Magnesium chloride is highly hygroscopic and found as a hydrate (MgCl₂(H₂O)ₓ), particularly as MgCl₂6(H₂O). In various embodiments, the water content x in the hydrate is not important. In various embodiments, the purity of magnesium chloride is at least 85%.

Magnesium chloro hydrate readily dissolves in water forming an ionic solvent releasing Mg²⁺ and Cl⁻ ions. In various embodiments, water and magnesium chloride are mixed at a ratio of about 1.5:1 to about 2.5:1. In one embodiment, water and magnesium chloride are mixed at a ratio of about 2:1, although in other embodiments, other ratios may be used. Any particles that do not dissolve are impurities and can therefore be removed using processes such as filtering, sedimentation etc. Further, in some embodiments, an additional dye may be added to the solution and dissolved to impart different coloration to the final product. In some embodiments, the dye may also be added along with the raw materials.

In a separate facility, magnesium oxide is crushed (if necessary) and sieved to remove larger particles (FIG. 4: step 430). In one or more embodiments, the particle size (which is also the sieve size during the sieving) of MgO is less than about 0.1 mm. In some embodiments, magnesium oxide may be dried to remove moisture prior to the sieving operation.

Next, the glue is formed. The magnesium oxide is mixed with the water comprising magnesium chloride (step 440). The solution comprising magnesium oxide and magnesium chloride is stirred in for about 10 minutes to about 30 minutes, and about 15 to about 20 minutes at a room temperature of about 30° C. The magnesium chloride reacts with magnesium oxide in an exothermic reaction releasing heat and thereby forming a pre-glue mixture comprising ([(m(MgO))nMg²⁺(2n-x)Cl⁻]^{x+}xCl⁻) and water (FIG. 4: step 450).

As the reaction proceeds, the magnesium cement matrix ([(m(MgO))nMg²⁺(2n-x)Cl⁻]^{x+}xCl⁻) precipitates out, while the water evaporates due to the exothermic nature of the reaction. Further, advantageously, the exothermic nature of the chemical reaction minimizes the need for any heating, thereby minimizing energy consumption during the production process.

The reaction between magnesium oxide and magnesium chloride may be controlled as desired in various embodiments. Although in some embodiments, the pre-glue mixture may be directly used as a glue solution, in various embodiments, a catalyst may be added to the pre-glue mixture (FIG. 4: step 460). In various embodiments, the catalyst accelerates the agglutination process within the pre-glue mixture (glue solution), wherein the colloidal particles within the pre-glue mixture adhere together during the agglutination process. In various embodiments, the catalyst may comprise K₂SO₄, ZnSO₄, CuSO₄, and/or K₃(Fe(CN)₆). In one embodiment, a solution of K₂SO₄ (potassium sulphate) may be added as the catalyst. In one case, the volume ratio of K₂SO₄ to the volume of MgO and MgCl₂ is about 0.05%.

Alternatively, in some embodiments, the water mixture comprising magnesium oxide and magnesium chloride may be heated to increase the reaction rate. For example, in some embodiments the water mixture may be heated mildly to less than 100° C.

In an alternative embodiment, if the reaction between magnesium oxide and magnesium chloride is too fast and the mixture rapidly heats up, retardants may be added. As an example, boric acid may be added to the mixture, which forms a protective layer over the magnesium oxide thereby reducing its reactivity. Alternatively, the volume of water may be increased and/or the catalyst is added within a short time (e.g., about 10 minutes) prior to mixing the organic fiber particles 120.

As next described in step 230 of FIG. 2, a slurry is formed by mixing the glue with the ground raw materials (e.g., organic fiber particles) from step 210 of FIG. 2. The slurry is formed by combining about x % by weight of the glue with about y % by weight of organic fiber particles. In various embodiments, x is about 60-80 and y is about 40-20. In one embodiment, 70% by weight of glue is mixed with 30% by weight of organic fiber particles. However, because of the lower density of the organic fiber particles, the organic fiber particles will comprise about 70% to about 80% of the total volume of the slurry. The mixture is mixed to reach a uniform consistency. However, the mixing process should not take too long to avoid loosing humidity before the shaping process. Therefore, the mixing process is performed for about 10 minutes to about 30 minutes in various embodiments.

Referring to step 240 of FIG. 2, the slurry is shaped to create the form of the required product. In various embodiments, a molding process is used. In a molding process, unlike a patterning process, a negative of the product to be formed is created in a mold.

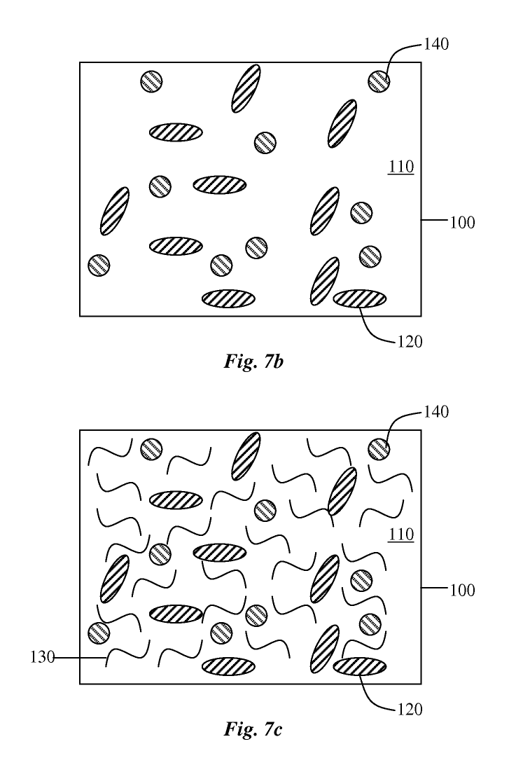

A molding process is illustrated in FIG. 5 in accordance with embodiments of the invention. Referring to step 510 of FIG. 5, a slurry is poured into a mold cavity. The slurry being viscous assumes the shape of the mold cavity. In various embodiments, complex products can be fabricated using this process. In various embodiments, the slurry may be introduced into the mold cavity by spraying, injecting, pouring etc. The viscosity of the slurry may be adjusted with the concentration of water in the mixture. For example, for use with injection molding more water may be added than for use with compression molding.

Additional pressure may be used to improve surface finish and increase the density of the slurry (step 520). The viscosity of the slurry may be controlled such that different types of molding may be used in various embodiments. For example, in one embodiment, the slurry may be made to be more viscous for using injection molding. Alternatively, in another embodiment, a less viscous liquid may be used for using compression molding. Excess slurry may be removed (step 530) and the slurry is allowed to set to form a composite material casting (step 540).

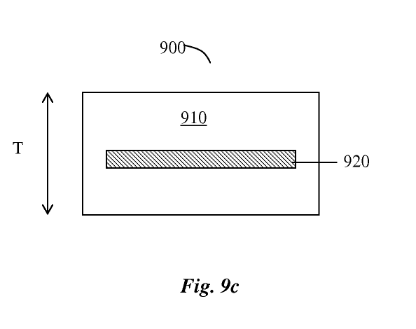

In an optional embodiment, reinforcements may be added to increase the load bearing capacity of the structure, as described further with respect to FIG. 9. In one embodiment, glass strings are woven together forming a fabric. The woven glass strings are folded together forming a fabric preform. The fabric preform is placed into the mold cavity before introducing the slurry. The slurry is poured over the fabric preform. After pouring the slurry, an additional fabric preform may be placed. Thus, an outer layer comprising the fabric preform is formed over the slurry after it sets.

The setting process may take many hours at room temperature. In one or more embodiments, the setting process takes about 8 to about 15 hrs depending on various external and internal conditions. External conditions include atmospheric temperature and humidity while internal conditions include product dimensions and type of slurry being used. The chemical reaction progresses to completion during the setting process as follows.

mMgO+nMg²⁺+2nCl⁻→(m(MgO))nMg²⁺(2n-x)Cl⁻]^{x+}xCl⁻+ΔH

Further, because of the exothermic nature of the reaction (noting the release of energy ΔH above), water (moisture) is naturally released from the slurry without additional heating.

The mold and the casting are next separated (FIG. 5: step 550). The mold may comprise a material that does not bind with the slurry thereby facilitating separation between the casting and the mold. In one embodiment the mold comprises a plastic.

Advantageously no toxic or green house gases are out-gassed during the setting process. As discussed above, only water evaporates during the setting process. Therefore, embodiments of the invention do not require expensive air filtering equipment.

Next, as illustrated in step 250 of FIG. 2, the separated casting is finished to final product. During finishing, any excess material is trimmed, and the casting is cleaned. Further, finishing may include surface polishing, painting etc as is known to one skilled in the art.

As next illustrated in step 260 of FIG. 2, a waste treatment is described. The waste treatment process enables to minimize the wastes from the production. In various embodiments, the waste treatment process dramatically reduces both solid and liquid waste thereby minimizing or even eliminating any effluents into the environment.

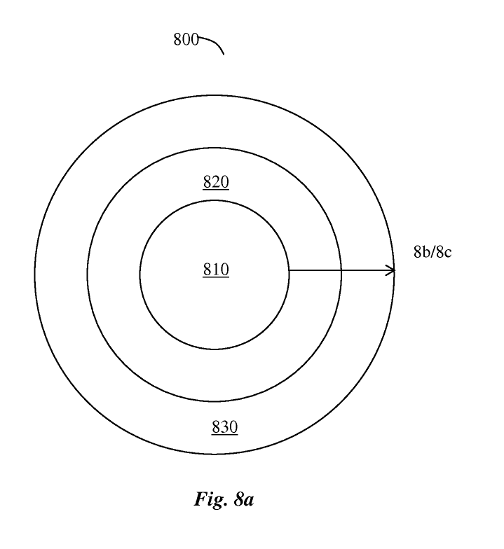

FIGS. 6a and 6b describe waste treatment operations in accordance with embodiments of the invention, wherein FIG. 6a describes liquid waste water operations, and wherein FIG. 6b describes solid waste operations.

Referring to FIG. 6a, the waste water from various operations is collected (step 610). The waste water may include water from cleaning the mold, raw materials, as well as cleaning of machinery used in the various steps. The waste water is filtered to obtain a solid waste which includes organic fibers including small powders (step 620). Further, any remaining magnesium oxide is recovered (step 630).

After recovering the insoluble magnesium oxide, the remaining liquid can be recycled (step 640). The remaining liquid may comprise some dissolved magnesium chloride. The concentration of magnesium chloride in the remaining liquid is measured. In one embodiment, this remaining liquid is recycled to form magnesium chloride water mixture (step 410 in FIG. 4). The magnesium chloride in the waste water is thus recycled. Alternatively, the remaining liquid may be used as glue and mixed directly with organic fiber particles. Thus, no liquid is released into the environment.

Solid waste operations are next described in accordance with embodiments of the invention using FIG. 6b. Solid waste is produced after cutting processes (such as trimming the final product), calibration and test processes, and surface cleaning processes. Solid waste is collected and finely ground (steps 660 and 670). The ground waste material is blended to the mixture of raw materials up to about 5% by weight. In one embodiment solid waste from about 1% to about 3% by weight is added to the raw materials preparation in step 210 of FIG. 2.

Thus embodiments of the invention describe a green production process that uses very little energy by leveraging the chemical reaction, and releases no polluting gases, liquids, or solids to the environment.

FIG. 7, which includes FIGS. 7a-7c, illustrates a structure of a composite material in accordance with embodiments of the invention.

In the embodiment described with respect to FIG. 1, only organic fiber particles 120 are illustrated as being disposed in a magnesium cement matrix 110. However, in various embodiments, the magnesium cement matrix 110 may include other types of particles.

Referring to FIG. 7a, the composite material 100 may include glass fibers 130 such as fiber glass particles. For example, the addition of fiber glass particles may improve the yield strength of the composite under tensile loading, as well as further improve thermal and electrical insulation.

Referring to FIG. 7b, the composite material 100 may include metal particles 140. The metal particles 140 may be introduced, for example, to absorb mechanical energy as plastic deformation and providing higher resistance to fracture. The metal particles 140 may also help to tailor the coefficient of expansion of the composite material 100, which may be important in many applications.

FIG. 7c illustrates a hybrid composite having organic fiber particles 120, glass fibers 130, and metal particles 140. The processes described with respect to FIGS. 2-6 can be used in forming the hybrid composite because of the excellent binding of the glue with both organic, inorganic, and metallic materials.

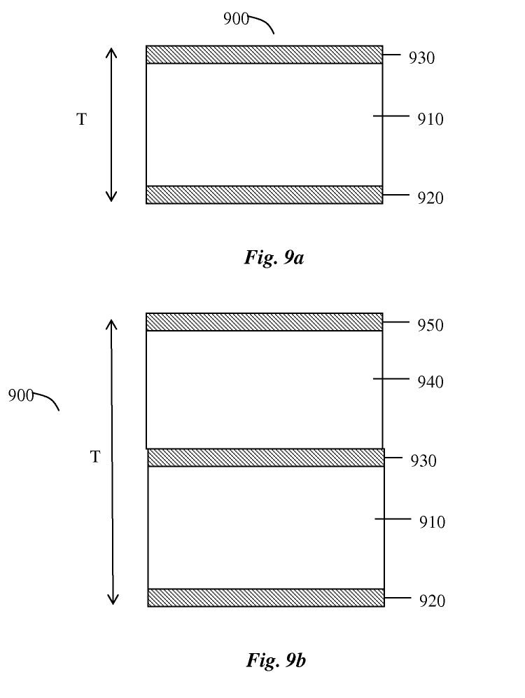

FIG. 8, which includes FIG. 8a-8c, illustrates a structural composite in accordance with an embodiment of the invention. The structural composite 800 illustrated in FIG. 8a is a cross sectional view, whereas FIGS. 8b and 8c illustrate 1-D concentration profile in alternative embodiments.

In one embodiment, the structural composite 800 may be a pillar, for example, a load bearing tower of a building. Alternatively, in other embodiments, the structural composite 800 may be any structure used for high temperature applications. Examples include reactors, engines, turbines, aircrafts, spacecrafts etc.

The structural composite 800 comprises a core metallic region 810. In one or more embodiments, the metallic region 810 comprises an iron alloy such as steel. In alternate embodiments, the metallic region 810 may comprise non-ferrous alloys especially in applications where the weight to (tensile) strength ratio is important. For example, for applications in aeronautics, the metallic region 810 may comprise titanium alloys.

The metallic region 810 is covered or surrounded by a first composite material layer 820 and a second composite material layer 830. The first and the second composite material layers 820 and 830 are formed as described above in various embodiments. The first and the second composite material layers 820 and 830 may be formed over the metallic core region in a site separate from the construction facility. Alternatively, in some embodiments, the slurry forming the composite material layers may be applied on-site.

In one embodiment, the first composite material layer 820 has a higher concentration of metal particles 140 than the second composite material layer 830 as illustrated in the 1-D profile of FIG. 8b. Referring to FIG. 8b, the organic fiber particles concentration may be higher in the second composite material layer 830 than in the first composite material layer 820.

In some embodiments, the second composite material layer 830 may not include any metal particles. The change in the metal particles 140 concentration changes the effective coefficient of thermal expansion locally. Therefore, the metal rich first composite material layer 820 has a higher thermal coefficient of expansion than the second composite material layer 830.

Further, the metal rich layer can deform locally without cracking the outer layers. As the composite structure heats and cools with the local weather, the metallic region 810 also heats or cools accordingly. The metal having a high thermal expansion will expand and contract accordingly. The presence of the metal rich first composite material layer 820 minimizes the stress at the interface between the composite material and the metallic region 810 and prevents cracking and de-lamination.

The composite material over the metallic region 810 can provide thermal protection to the composite structure and therefore, e.g., to the building without any significant increase in construction costs. For example, because of the excellent insulation properties of the composite building, the critical load bearing structures can be relatively immune to building fires.

In some embodiments, both the first and the second composite material layers 820 and 830 are formed as a single layer. In such alternative embodiments, a single composite material layer may be formed around the metallic region. The single composite material layer 830 comprises a metal particle concentration that decays radially outward with a maximum adjacent the metallic region 810. In other embodiments, the single composite material layer has a substantially uniform particle concentration throughout.

In some embodiments, the organic fiber particles in the first and the second composite material layers 820 and 830 may be supplemented with glass string fibers. In one embodiment, all the organic fiber particles in the first and the second composite material layers 820 and 830 may be replaced with glass string fibers. Alternatively, the first and the second composite material layers 820 and 830, which may be a single composite material layer, may be covered with a glass fabric as described in the embodiment of FIG. 9.

FIG. 9, which includes FIGS. 9a-9c, illustrates a structural composite in accordance with an alternative embodiment of the invention. FIG. 9 is a cross-sectional view of the structural composite.

Referring to FIG. 9a, a composite 900 includes a core region, which comprises a bio-composite material 910. In various embodiments, the bio-composite 910 is a composite material as described with respect to embodiments of FIGS. 1 and/or 7.

The composite 900 further comprises a first reinforcement layer 920 and a second reinforcement layer 930. The first reinforcement layer 920 is disposed over a top surface of the bio-composite material 910. The second reinforcement layer 930 is disposed over an opposite bottom surface of the bio-composite material 910. The bio-composite material 910 comprises a magnesium cement matrix having organic fiber particles, for example, as described above with respect to FIG. 1.

In various embodiments, the first and the second reinforcement layers 920 and 930 cover most of the exposed surface of the bio-composite material 910. While not illustrated, the composite 900 may comprise any shape including basic shapes such as spherical, cubic, hexagonal, orthorhombic etc. Embodiments of the invention also include complex shapes that are a combination of many basic shapes.

In various embodiments, the first and the second reinforcement layers 920 and 930 comprise fiber glass including woven glass strings also known as fiber preforms. In one embodiment, the first and the second reinforcement layers 920 and 930 comprise a fabric including fiberglass, steel, or bamboo, as examples.

FIG. 9b illustrates an alternative embodiment showing multiple reinforcement layers. Only as example, FIG. 9b showing three reinforcement layers, although in other embodiments, more number of reinforcement layers may be used. For example, in FIG. 9b, besides the first and the second reinforcement layers 920 and 930, a third reinforcement layer 950 is used.

As illustrated in FIG. 9b, another bio-composite material 940 is disposed between the second and the third reinforcement layers 930 and 950. Similar to the bio-composite material 910, the other bio-composite material 940 comprises a magnesium cement matrix having organic fiber particles, for example, as described with respect to FIG. 1. In one embodiment, the bio-composite material 910 and the other bio-composite material 940 are the same material. In an alternative embodiment, the bio-composite material 910 and the other bio-composite material 940 have different properties. For example, this may allow the composite 900 to better match the physical or thermal properties of the materials that will be used adjacent the top and/or bottom surface of the composite 900.

In various embodiments, the first, the second, and the third reinforcement layers 920, 930, and 950 may comprise any other reinforcing material known to a person skilled in the art.

FIG. 9c illustrates an alternative embodiment wherein the reinforcement forms the core of the material. Referring to FIG. 9c, a composite 900 includes a core region, which comprises a first reinforcement layer 920. The first reinforcement layer 920 may comprise suitable reinforcement materials including bamboo or steel.

In this embodiment, a bio-composite material 910 surrounds the core region comprising the first reinforcement layer 920. In various embodiments, the bio-composite 910 is a composite material as described with respect to embodiments of FIGS. 1 and/or 7. This embodiment may be used in forming wooden bars such as standard sized bars (4″×4″, 2″×4″, etc).

In various embodiments, the composite, e.g., illustrated in FIGS. 9a-9c, may be used for forming composite boards. In one embodiment, the composite board may be used to fabricate doors and other applications requiring high density materials having good mechanical and thermal properties. Alternatively, the composite 900 may also be used in the construction industry as wood like poles including beams, bricks and/or prefabricated slabs.

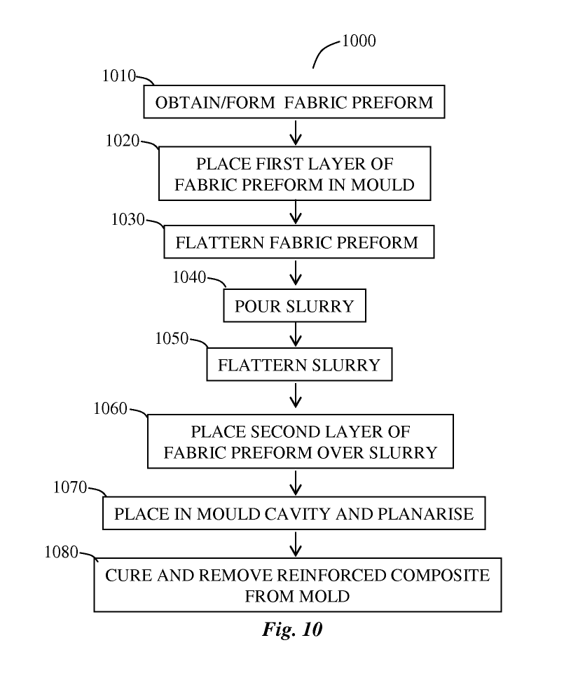

FIG. 10 illustrates process operations 1000 in forming a fiber reinforced composite in accordance with an embodiment of the invention. In one embodiment, FIG. 10 illustrates a method of forming the composite illustrated in FIG. 9.

Referring to step 1010 of FIG. 10, the fabric preform is first fabricated or obtained. In various embodiments, the first and the second reinforcement layers 920 and 930 may comprise a three-dimensional preform or a two-dimensional fiber preform. In a two-dimensional fiber preform, the fiber preform comprises glass strings or fiber aligned along x-axis and y-axis but not the z-axis (the z-axis being oriented along the thickness T in FIG. 9). In contrast, in a three-dimensional fiber preform, the fiber preform comprises glass strings or fiber aligned along x-axis, y-axis, and z-axis. The fiber preforms may be manufactured using braiding, stitching, knitting, weaving, and other processes known to one skilled in the art.

In one or more embodiments, a first layer of the fabric preform is placed on a flat surface, e.g., a temporary mold cavity, within a molding machine (step 1020). The first layer of fabric preform may be flattened (step 1030) using, for example, a roller. The slurry, as described above (see, e.g., FIG. 2), is poured over the fabric preform (step 1040). The slurry may be rolled, for example, using a two-axis roller. The two-axis roller moves over the top and bottom surfaces, wherein each roller rotates in the direction opposite to the other roller. Thus, the slurry or composite board being formed is squeezed between the two-axis roller, and flattens or planarizes the top surface of the poured slurry (step 1050). Additional pressure may be used during the flattening process to compact the slurry thereby increasing the density of the final product. In some embodiments, further polishing of the slurry top surface may be performed to further reduce the surface roughness.

A second layer of the fabric preform is placed on the top surface of the flattened slurry (step 1060). Optionally, the composite slurry-reinforcement layer structure may be compacted further and flattened.

Embodiments of the invention also include multiple layers of reinforcement. The above process will be repeated, for example, after pouring a second round of slurry over the second layer of the fabric preform.

Next, the composite slurry-reinforcement layer may be placed within a plastic mold and flattened/rolled further to achieve the desired thickness, e.g., the thickness T in FIG. 9, of the final product (step 1070). The mold is allowed to cure, for example, for 8 hrs to 12 hrs (step 1080). The cured product is removed from the plastic mold. Further, finishing operations may follow as described above, for example, in FIG. 2 (finishing 250).

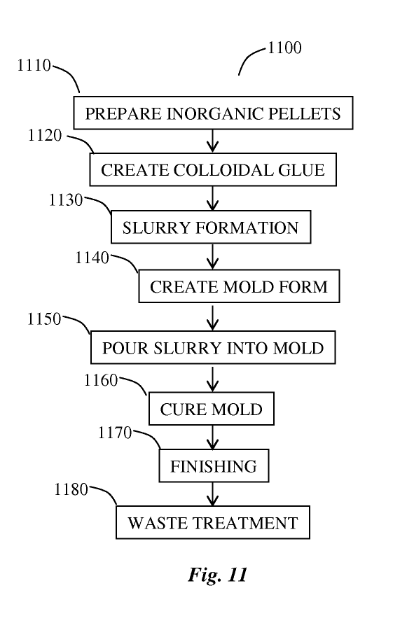

FIG. 11 illustrates process operations 1100 in forming marble composites in accordance with an embodiment of the invention.

In this embodiment, different raw materials are used. In one embodiment, as illustrated in step 1110, the organic raw materials may be replaced with inorganic materials such as quartz, calcium carbonate, or other materials having a larger hardness. For example, in some embodiments, the inorganic materials may comprise minerals including calcite, dolomite, and/or serpentine. Any crystalline material having a suitable harness (e.g. having at least a hardness of 3, preferably at least 4, in the Mohs scale) may be used. In some embodiments, organic raw materials (e.g., as described with respect to FIG. 3) may also be included along with the inorganic materials. The inorganic materials are sorted and grinded if necessary to form small pellets having particle dimensions less than about 1 mm. The shapes, colors, and other properties of the pellets can be selected based on the required design of the final product.

Next, as in step 1120, the colloidal glue is formed as in prior embodiments, for example, as described with respect to step 220 in FIG. 2 and FIG. 4. However, in this embodiment, the relative content of water is reduced in the glue. For example, in one or more embodiments, water and magnesium chloride is mixed at a ratio of about 1:1 to about 0.8:1.

Referring to step 1130, the slurry is formed by mixing the inorganic pellets formed in step 1110 with the glue formed in step 1120. In one embodiment, the ratio of the inorganic pellets to the glue is about 0.8:1 to about 1.2:1, and about 1:1 in one embodiment. Consequently, this ratio is less than used for organic fiber particles described with respect to step 230 of FIG. 2. The lower ratio of glue helps to increase the hardness of the final product.

As next show in step 1140, a mold casing is designed. The mold casing may comprise a plastic material in one embodiment. The mold casing may be formed using computer aided design followed by laser carving. The slurry mixture is poured into the mold casing (step 1150). The slurry may be compressed, e.g., using a vibratory roller, to increase the density, for example, at a vibration frequency of about 3,000 cycles/min to about 6,000 cycles/min.

The mold is allowed to set and cure for about 10 hrs to about 12 hrs at room temperature (step 1160). The mold is separated from the mold casing (step 1170) and polished to form marble like product. The marble like product has a hardness of at least 4 in the Mohs scale, and preferably at least 5. Remaining waste is recycled as described in other embodiments. Using this embodiment, marble like slabs may be formed.

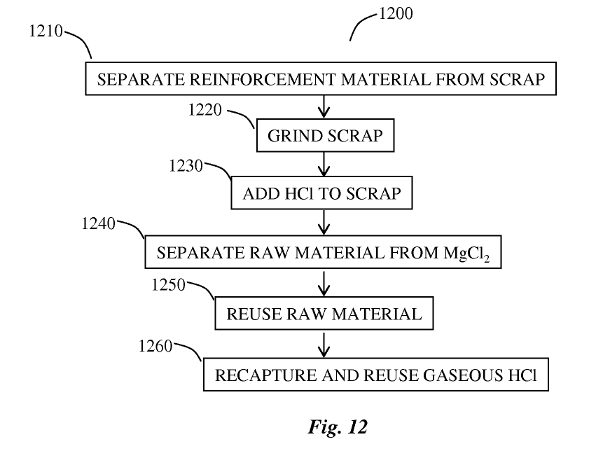

FIG. 12 illustrates alternative waste treatment operations 1200 in accordance with embodiments of the invention.

This embodiment may be utilized for large amount of scrap or solid waste. Solid waste is produced as in prior embodiments described, e.g., with respect to FIG. 6b.

As illustrated in step 1210, the scrap material is sorted to separate reinforced materials such as bamboo, steel etc. from the scrap. The scraps are then ground into smaller pieces through a grinding machine (step 1220). The amount of magnesium oxide in the scrap is estimated.

A suitable amount of hydrochloric acid is added to the scrap (step 1230). In various embodiment, hydrochloric acid diluted to about 25% to about 50%, e.g., 35% is used. The hydrochloric acid reacts with any remaining n moles of MgO and forms hydrated magnesium chloride, for example, as nMgO (in scrap)+nHCl+5nH₂O→n(MgCl₂6(H₂O)).

The extracted hydrated magnesium chloride and any remaining magnesium chloride can now be separated, e.g., by filtering, from the organic fiber particles and/or inorganic pellets (step 1240). The extracted organic fiber particles and/or inorganic pellets can be reused (step 1250). The system is also designed to recapture any hydrochloric acid escaping in gaseous form (step 1260).

Although the present invention and its advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-14. (canceled)

15. A method of forming a composite material, the method comprising:
drying organic raw material to remove moisture to less than about 18%;
milling the dried organic raw material to form organic fiber particles having a size less than about 10 mm;
forming a glue by adding magnesium oxide, magnesium chloride, and water;
forming a slurry by mixing the glue with the organic fiber particles;
filling a mold cavity of a mold with the slurry; and
forming a pattern by allowing the slurry to set within the mold cavity.

16. The method of claim 15, wherein the organic raw material comprises a material selected from the group consisting of grass, straw, husks such as rice husks, wheat husks, corn husks, bagasse, bamboo, and corn cobs.

17. The method of claim 15, wherein molding the slurry comprises using injection molding, pressure molding, or compression molding.

18. The method of claim 15, wherein forming the glue comprises adding a catalyst to a pre-glue mixture formed by adding magnesium oxide, magnesium chloride, and water.

19. The method of claim 18, wherein the catalyst is K₂SO₄.

20. The method of claim 18, wherein the catalyst is selected from the group consisting of ZnSO₄, CuSO₄, and K₃(Fe(CN)₆).

21. The method of claim 15, further comprising:
removing the pattern from the mold cavity;
cleaning the mold with water; and
collecting waste water from cleaning the mold.

22. The method of claim 21, wherein the waste water comprises water after cleaning components used in forming the composite material.

23. The method of claim 21, further comprising:
filtering the waste water to form recycled fibers;
recovering magnesium oxide by sedimentation; and
adding remaining liquid in the waste water to a pre-glue mixture used for forming another pattern.

24. The method of claim 21, wherein waste from forming the pattern of the composite material is reused in forming another pattern of the composite material, and wherein no toxic byproducts are released to the atmosphere in forming the composite material.

25. The method of claim 15, further comprising:
collecting solid waste from cleaning the mold and finishing the pattern;
grinding the solid waste; and
incorporating the ground solid waste with milled organic raw materials used for forming another pattern, wherein the ground solid waste is about 3% in weight in the organic raw materials used for forming the another pattern.

26. A method of forming a composite material, the method comprising:
milling an inorganic crystalline material to form pellets having a size less than about 1 mm;
forming a glue by adding magnesium oxide, magnesium chloride, and water;
mixing the glue with the pellets to form a slurry;
filling a mold cavity of a mold with the slurry; and
forming a pattern by allowing the slurry to set within the mold cavity.

27. The method of claim 26, wherein the inorganic crystalline material comprises quartz, and/or a form of calcium carbonate.

28. The method of claim 26, wherein the pattern has a hardness of at least 5 in the Mohs scale.

29. The method of claim 26, wherein forming a glue comprises adding water and magnesium chloride at a ratio of about 1:1 to about 0.8:1, and wherein mixing the glue with the pellets comprises adding glue and pellets at a ratio of about 0.8:1 to about 1.2:1.

30. A production process for making a composite material, the process comprising:
drying organic raw material to remove moisture to less than about 18%;
milling the organic raw material to form organic fiber particles having a size less than about 10 mm;
incorporating ground solid waste with the organic fiber particles;
forming a pre-glue mixture by adding magnesium oxide, magnesium chloride, and water;
adding a catalyst to the pre-glue mixture to form a glue, wherein the catalyst is selected from the group consisting of K₂SO₄, ZnSO₄, CuSO₄, and K₃(Fe(CN)₆);
mixing the glue with the organic fiber particles to form a slurry;
filling a mold cavity of a mold with the slurry; and
forming a pattern by allowing the slurry to set within the mold cavity, wherein the ground solid waste is a scrap product of the production process.

31. The production process of claim 30, further comprising:
removing the pattern from the mold cavity;
cleaning the mold with water;
collecting waste water from cleaning the mold;
filtering the waste water to form recycled fibers;
recovering magnesium oxide by sedimentation;
recovering magnesium chloride; and
adding remaining liquid to a pre-glue mixture used for forming another pattern.

32. The production process of claim 30, wherein no toxic byproducts are released to the atmosphere in forming the composite material.

33. The production process of claim 30, wherein the ground solid waste is obtained after extracting magnesium chloride from the scrap product, and wherein forming a pre-glue mixture by adding magnesium oxide, magnesium chloride, and water comprises adding at least a portion of the extracted magnesium chloride.

34. The production process of claim 33, wherein extracting magnesium chloride comprises adding hydrochloric acid to the scrap product.

35. The method, of claim 15, wherein, after forming the pattern, the pattern within the mold cavity comprises:
a magnesium cement matrix comprising the magnesium oxide and the magnesium chloride; and
wherein the organic fiber particles are disposed in the magnesium cement matrix, the organic fiber particles having less than 15% moisture, wherein the organic fiber particles are less than 10 mm in size, and wherein the magnesium cement matrix and the organic fiber particles form the composite material.

36. The method of claim 35, wherein a volumetric content of the magnesium cement matrix in the composite material is less than about 20%, and wherein the magnesium cement matrix comprises ([(m(MgO))nMg²⁺(2n-x)Cl⁻]^{x+}xCl⁻).

37. The method of claim 35, wherein a bending endurance of the composite material is at least 14 MPa, wherein an impact endurance of the composite material is at least 2 Kg/m², and wherein a breakage endurance is at least 40 N/mm.

38. The method of claim 35, wherein a burning point of the composite material is at least 800° C., wherein a coefficient of expansion of the composite material is less than about 5×10⁻⁶ m/mK, wherein a volumetric expansion after water immersion is less than about 0.55%, and wherein the density of the composite material is about 0.9 to about 1.0 gm/cc.

39. The method of claim 35, further comprising:
milling an inorganic crystalline material to form pellets; and
forming the slurry by further mixing the glue with the pellets, wherein after forming the pattern, the composite material comprises the pellets disposed in the magnesium cement matrix, the inorganic crystalline material pellets having a size less than about 1 mm.

40. The method of claim 39, wherein the inorganic crystalline material pellets comprise quartz, and/or calcite, dolomite, and/or serpentine.

41. A method of forming a composite material, the method comprising:
forming a magnesium cement matrix comprising magnesium oxide and magnesium chloride; and
forming organic fiber particles disposed in the magnesium cement matrix, the organic fiber particles having less than 15% moisture, wherein the organic fiber particles are less than 10 mm in size; and
forming inorganic crystalline material pellets disposed in the magnesium cement matrix, the inorganic crystalline material pellets having a size less than about 1 mm, and wherein the magnesium cement matrix, the organic fiber particles, and the inorganic crystalline material pellets form the composite material.

42. The method of claim 41, wherein the composite material is a brick or a prefabricated slab.

43. The method of claim 41, wherein the composite material is a wood substitute.

44. The method of claim 41, wherein the composite material is a tile.

45. The method of claim 41, wherein the composite material is an insulating material for load bearing pillars of a building.

46. A method of forming a building, the method comprising forming a structural feature by forming a composite material, the method of forming the composite material comprising:
forming a magnesium cement matrix comprising magnesium oxide and magnesium chloride; and
forming organic fiber particles disposed in the magnesium cement matrix, the organic fiber particles having less than 15% moisture, wherein the organic fiber particles are less than 10 mm in size.

47. The method of claim 46, wherein forming the structural feature comprises forming a wall, wherein the wall comprises bricks having the composite material.

48. The method of claim 46, wherein forming the structural feature comprises forming a door or forming a load bearing pole of the building.
